(19) United States
(12) Patent Application Publication
(10) Pub. No.: US 2016/0342961 A1
(43) Pub. Date: Nov. 24, 2016

(54) Cash-to-electronic deposit gateway

(71) Applicant: Kenneth Brian Moultrie, University heights, OH (US)

(72) Inventor: Kenneth Brian Moultrie, University heights, OH (US)

(21) Appl. No.: 14/719,442

(22) Filed: May 22, 2015

(51) Int. Cl. G06Q 20/06; G06Q 20/10

(52) U.S. Cl. CPC G06Q 20/065; G06Q 20/108

(57) ABSTRACT

A cash-to-electronic deposit gateway will allow people to convert cash to electronic funds at any retail location. A customer at a non-bank, retail location can give cash to a cashier, who will request to initiate a transaction to credit an account in the amount of cash received. The cashier will give the customer a receipt with a confirmation number on it to complete the process depositing the funds to their bank account using a phone or computer.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE OR A COMPUTER PROGRAM LISTING COMPACT DISC APPENDIX

Not Applicable.

### BACKGROUND OF THE INVENTION

1. Field of the Invention

The present invention relates generally to electronic fund transfer technologies.

2. Description of the Related Art

In recent years there have been many patents issued for inventions involving the electronic transfer of money. However, all of these inventions convert money from electronic funds to cash money. Examples of these inventions include, but are not limited to, U.S. Pat. No. 8,725,640 B2, U.S. Pat. No. 8,715,066 B2, U.S. Pat. No. 8,548,907 B1, U.S. Pat. No. 8,275,714 B2, U.S. Pat. No. 7,771,277 B2, U.S. Pat. No. 6,766,306 B1, U.S. Pat. No. 6,304,915 B1, U.S. Pat. Nos. 5,978,840 and 5,650,604. The present invention, the cash-to-electronic deposit gateway, is unique in that it can be used to convert money from cash to electronic funds. It provides a solution for the person wanting to deposit cash into their bank account even when there is no local branch or ATM for their bank in the area.

### BRIEF SUMMARY OF THE INVENTION

The present invention is a cash-to-electronic deposit gateway which allows non-bank organizations like retailers to facilitate the conversion of cash money to electronic funds. The cash-to-electronic deposit gateway will allow retailers to issue credit to bank accounts. The credited account can be assigned or unassigned, but it will have a unique identifier. A cash-to-electronic deposit card can used to provide the customer with a unique account number (CASH-TO-ELECTRONIC DEPOSIT CARD).

### DESCRIPTION OF THE DRAWINGS

For a more complete understanding of the present invention, reference is now made to the following descriptions:

FIG. 1 Shows how to use the cash-to-electronic deposit gateway from the customer aspect.

FIG. 2 Shows how to use the cash-to-electronic deposit gateway from the cashier aspect.

### REFERENCE NUMERALS IN THE DRAWINGS

For a more complete understanding of the present invention, reference is now made to the following descriptions:
1—The customer.
2—The store.
3—The cashier.
4—The customer makes a cash purchase as normal but instead of the cashier returning the funds back to the customer, the cashier, upon request, accesses the cash-to-electronic deposit gateway system to initiate the conversion of the cash to electronic funds for deposit into the customer's bank account.
5—The cashier takes the cash and puts it in the store's register. The cashier goes into the cash-to-electronic deposit gateway system to submit a request to create a credit for the amount of the cash given to or retained by the cashier.
6—The cashier gets confirmation in the form of a unique number and gives it to the customer on a receipt or cash-to-electronic deposit card.
7—After the customer receives the receipt with a confirmation number indicating his cash has been converted to electronic funds, the customer types that unique code into his phone or computer to finalize the transaction and deposit the funds into his bank account.
8—The store computer contacts the database through the cash-to-electronic deposit gateway. The cash-to-electronic deposit gateway tells the store computer where and how to do a credit.

### DETAILED DESCRIPTION OF THE INVENTION

The following detailed description is the best of the currently contemplated modes of carrying out exemplary embodiments of the invention. The description, not to be taken in a limiting sense, is made merely for the purpose of illustrating the general principles of the invention. The present invention provides a solution to convert cash money to electronic funds at any retail location. For example, if you are visiting a city and you have cash that want to deposit into your bank account, it may be hard to find a branch of your bank or an affiliated bank machine. In this case, you have limited options available and none of them are ideal. You can't go to a bank machine of another bank because they don't allow cross-bank deposits. You can't go to your bank to make a deposit because it is too far away. You may be able to send yourself a wire, but this is expensive and can only be done in a limited number of places. Generally, in this situation, people choose to simply hold on to the cash which bears the risk of theft or lost. The present invention will solve this problem by establishing a payment (deposit) gateway that will either interface directly with banks or a holding institution that provides an interface where the cash holder can facilitate the transfer of funds. This can be accomplished by installing software on the merchant processing devices that facilitate the process. There are two faces for using the current cash-to-electronic deposit gateway. One is for the customer and the second is for the cashier.

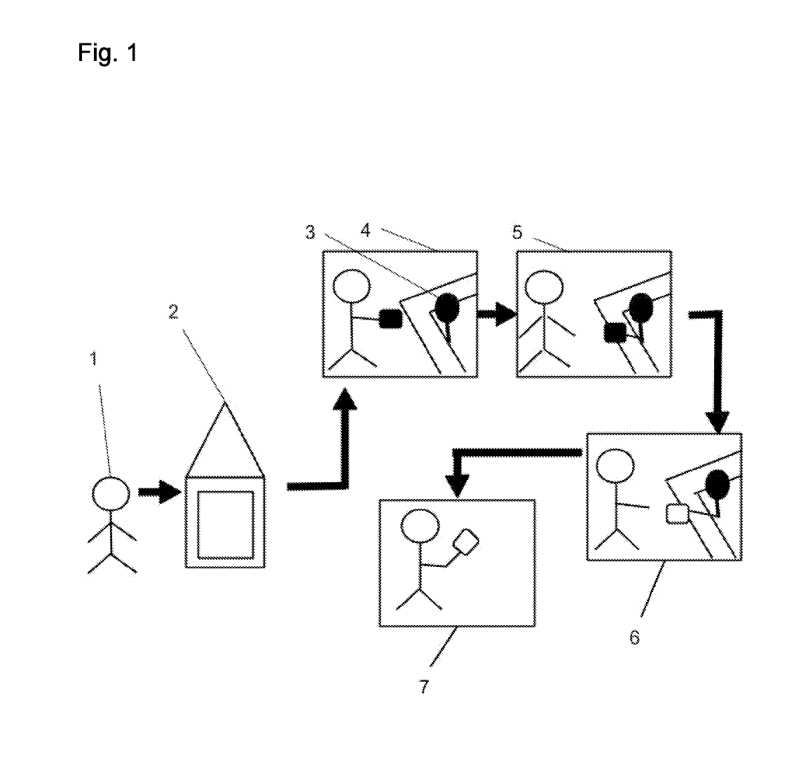

Referring to FIG. 1 we see the process from the customer aspect. A customer 1 will go to the store 2 and make a cash purchase but instead of the cashier 3 returning the funds back to the customer 1 the cashier 3 can upon request, use the cash-to-electronic deposit gateway to initiate the deposit of the customer's 3 cash into his bank account 4. The cashier 3 will take the cash and put it into the store's 2 register. The cashier 3 will go into the cash-to-electronic deposit gateway system to submit a request create a credit for the amount of cash retained 5. The cashier 3 will get the confirmation as a special number and give it to the customer 1 so he can complete the transaction 6. After the customer 1 receives the receipt with the special number indicating his cash prepared for deposit electronically, the customer 1 types that special number into his phone or computer and the newly converted funds are deposited into the bank, this code can be used by his bank to assign the funds to his account 7.

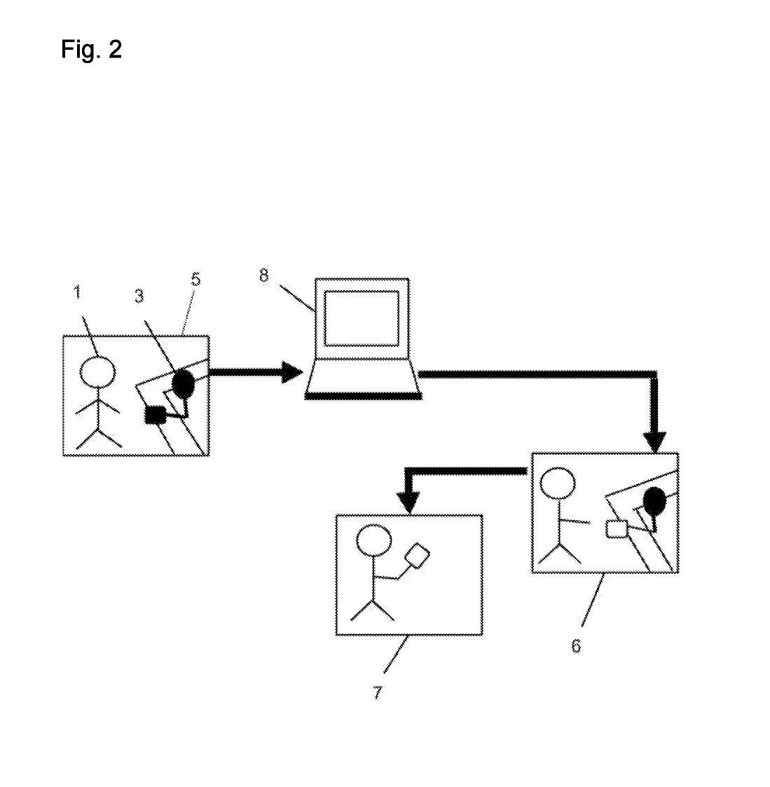

Referring to FIG. 2, we see the process from the cashier aspect. The cashier 3 will take the cash from the customer 1. Then the cashier 3 will submit a request to issue a credit to the customer's virtual account number 5 The store computer will contact the database through the cash-to-electronic deposit gateway. The cash-to-electronic deposit gateway will tell the store computer where and how to do a credit 8. The server will give the store computer a confirmation number back through the cash-to-electronic deposit gateway and the cashier 3 will give the customer 1 the confirmation number on a receipt 6. The customer 1 will go to his phone or computer and input the confirmation number to deposit the funds into his bank account 7.

A physical cash-to-electronic deposit card can be used as part of this process. The customer 1 can give the card to the cashier 3 who will activate it. The computer will record that the card is activated and use the number associated with the card instead of creating its own confirmation code. The credit will go to the unique number associated with the deposit card. To deposit the funds into his account, the customer 1 will input the number on the card using his phone or computer 7.

1. The cash-to-electronic deposit gateway could work on a credit card processing machine or integrate with a point of sale (POS) system to allow non-bank organizations like retailers to facilitate the conversion of cash money to electronic funds. The cash-to-electronic deposit gateway will allow the customer to go to a store and ask the cashier to deposit cash into his bank account. The cashier will collect the cash, put it in the store's register, enter the cash-to-electronic deposit gateway system and submit a request to create a credit for that same amount. The store's computer will contact the database through the cash-to-electronic deposit gateway. The cash-to-electronic deposit gateway will tell the store computer where and how to do the credit. The server will give the cashier a confirmation number to pass along to the customer. The customer will type that special number into his phone or computer to finalize the transaction. Electronic funds equal to the amount of cash the customer gave to the cashier will be deposited into the bank.

2. A physical deposit card can be used by the customer to facilitate this process. The customer can give the cash-to-electronic deposit card to the cashier at the start of the transaction. The cashier will activate the deposit card and the credit will go directly to the number of the card. The computer will record the deposit card number as activated and use it instead of creating its own code on a receipt. The customer will input the number on his deposit card using a phone or computer to deposit the funds into his bank account.
